(19) United States
(12) Patent Application Publication
(10) Pub. No.: US 2009/0228985 A1
(43) Pub. Date: Sep. 10, 2009

(54) Digital media content licensing and distribution methods

(76) Inventor: Jill Lewis Maurer, Raleigh, NC (US)

Correspondence Address: TRIANGLE PATENTS, P.L.L.C., P.O. BOX 28539, RALEIGH, NC, 27611-8539, US

(21) Appl. No.: 12/075,201

(22) Filed: Mar. 10, 2008

(51) Int. Cl. G06F 21/00

(52) U.S. Cl. 726/26

(57) ABSTRACT

Methods for doing business based on licensing intellectual assets, including rights to access digital media content through a managed website for providing network-based access to authorized users who pay for predetermined rights that allow for use of the content by the authorized user on a multiplicity of devices, without having to repurchase access to the same content.

### BACKGROUND OF THE INVENTION

1. Field of the Invention

The present invention relates generally to digital media content licensing and distribution. Further, the present invention relates to digital media creation, upload, download, and rights acquisition by users of a network-based system and methods of using the same.

2. Description of the Prior Art

Historically, music and entertainment was provided solely in a live format, wherein the audience only had real-time, live access to the performance. If someone wanted to access the music and entertainment, one had to travel to be in person for the performance. If payment was required, it would be on a pay-per-attendance basis made at the time the performance was rendered. Still music, plays, readings and other performances were documented on paper and issues of copyright infringement or plagiarism were relevant and problematic, in particular being difficult to monitor and police. Early and distributed release of the documented music by the actual or true author was one possible solution to these problems, although far from completely addressing the issues.

Later, music companies or record labels were established to manage the release and distribution of music and other entertainment. Publishing companies were similarly situated to manage written works, including texts, art, and the like. While distribution of the music and entertainment improved, the selection and timing of release was made by the third party companies, rather than by the artist or the consumer. So many talented artists and authors created works that were still nearly impossible to distribute or promote, in particular beyond time and geographic constraints. Recording and producing the music and entertainment, including digital mastering, was essentially controlled and managed by a few companies, rather than the artists and authors. Artists are paid very small fees, usually less than 10% of revenue from sales. Most of the ownership rights or copyrights were required to be assigned to the companies rather than being retained by the authors in exchange for the selective distribution, which frequently resulted in artistic compromise or censorship.

Compensation is required for the creating and distributing parties within the entertainment equation, otherwise, new content of quality will not be regularly created. While some Internet websites like iTunes at www.apple.com/itunes provide for on-demand download to users having accounts who pay for rights to download copies, these sites do not provide for the user to play or download to a multiplicity of devices, with the exception of backup copies. Users can selectively access content they want, buying on a per-song or per-album basis, and similarly on a per-book or per-movie basis. While this scenario and business model improves distribution and helps to avoid some of the illegal downloading by making access to content affordable, the costs are still expensive and comparable to traditional recording industry standards for purchasing a copy of the content on a CD or DVD format (where you buy the DVD or CD with a copy of the content, but you don't actually own the content, for example if the DVD or CD is damaged or stolen, you don't get a free replacement for the copy you already purchased). iTunes provides for a user to download music, movies, audio books, and the like into a library that must be stored on the user's computer. iTunes does not retain the library for each user on its site; thus, if anything is lost or damaged or the computer is stolen, the library and the valuable content on it are no longer accessible by the user who rightfully owns that content, based on the licenses purchased.

Another website with content available through the Internet is youTube at www.youtube.com; it provides free content for play by any user on the site, and that free content is uploaded without review or confirmation of authorship or rights ownership, much less screened for quality or interest by users.

In both of the aforementioned cases, users can provide feedback or rating of the content. And the content may be categorized by subject or genre or artist. To some limited extent, it may also be searched through the website.

The Internet and web-based media distribution, along with the improvement of electronic devices for creating digital representations of works, has changed the entertainment scene; however, the industry—especially music, movies, and broadcast media (perhaps with the exception of XM radio)—has not significantly changed the business model for providing digital entertainment content to authorized users. The traditional industry position has held that its position is based on the protection of copyrights and other intellectual property; in fact, copyright infringement and illegal downloading have been problematic for a long, long time. The Internet alone has not addressed the problem of providing diverse, on-demand content to authorized users at reasonable rates, while providing reasonable compensation to artists and authors for participating in a structured, managed format.

Licensing and distribution are closely related activities. With the evolution of digital media distribution, there has also developed a need for an updated business and legal models for licensing rights, management, and enforcement of them in connection with web-based distribution of digital media content. Thus, there remains a need for systems and methods that provide for automatic digital content licensing and distribution through a managed website for providing network-based access to authorized users who pay for predetermined rights that allow for use of the content by the authorized user on a multiplicity of devices, without having to repurchase access to the same content.

### SUMMARY OF THE INVENTION

A first aspect of the present invention is to provide a method for providing licensing rights for intangible assets including the steps of providing at least one intangible asset available for licensing; providing automatically managed access to a licensed user following the user's acceptance of agreed upon terms for licensing, wherein the licensing terms are established or generated by the creating user; wherein the access to the at least one intangible asset in a digital format by the licensed user is provided via a network, through a website having an interactive user interface, and wherein the at least one intangible asset in digital format is retained remotely on a computer server, thereby providing a business model for automatically managing licensed rights with remote, electronic access to the at least one asset in a digital representation format.

Another aspect of the present invention includes a method for providing digital media for distribution to users over a network including the steps of providing a digital representation of media (DRM) available for distribution over a network, wherein the DRM is provided in a digitally recorded format (DRF) and transmittable remotely to a network portal for upload to a website; and providing the DRM in DRM unit(s) stored remotely at a data storage site(s) available for selective download by authorized users of the network who access website (through the network portal) remotely and who are associated with an active account through the website; wherein the DRF and license terms are provided by a creator of the DRF at the time of upload to the system; and wherein the license fees are based upon DRM units.

Still another aspect of the present invention is to provide an automated license management method for digital media access via a network and remote content storage wherein licensed users are provided access to digital media through authorized accounts, and wherein the digital media is stored remotely, such that the licensed user has repeat access to the remotely stored media.

Thus, the present invention provides completely remote access to DRM that is maintained by someone other than the authorized user, wherein the user has access to download and play the DRM units based upon actual simultaneous play of any DRM unit, regardless of the format or type of device on which the DRM units are played or accessed by the user.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram of the method according to one embodiment of the present invention.

FIG. 2 is a schematic diagram of the system supporting the methods of use, in accordance with an embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a system and methods that provide for digital content creation and upload through a managed website for providing network-based access to authorized users who pay for predetermined rights that allow for use of the content by the authorized user on a multiplicity of devices, without having to repurchase access to the same content to address the longstanding, unmet needs within the entertainment industry to address interests of consumers, artists and authors, and the entity managing and securing authorized, legal rights to distribute and sell access to that digital content, on demand by authorized users.

More particularly, the present invention is directed to a method for providing licensing rights for intangible assets including the steps of providing at least one intangible asset available for licensing; and providing automatically managed access to a licensed user following the user's acceptance of agreed upon terms for licensing, wherein the licensing terms are established or generated by the creating user, or selected or agreed to by the user based upon guidelines or basic terms required for an effective licensing agreement; wherein the access to the at least one intangible asset in a digital format by the licensed user is provided via a network, through a website having an interactive user interface, and wherein the at least one intangible asset in digital format is retained remotely on a computer server. This sets forth a business model for automatically managing licensed rights with remote, electronic access to intangible assets, specifically media content, in a digital representation format.

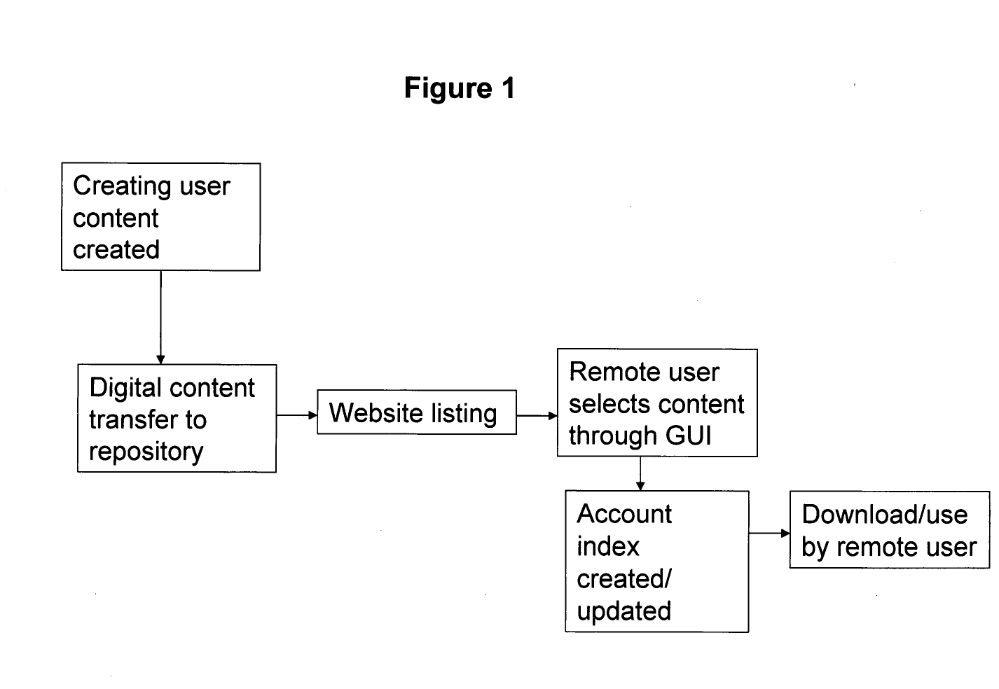

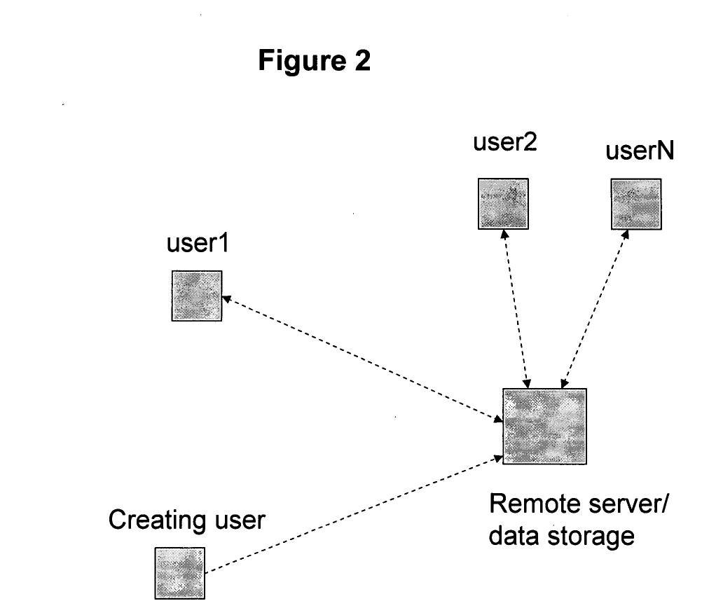

Referring now to the drawings in general, the illustrations are for the purpose of describing a preferred embodiment of the invention and are not intended to limit the invention thereto. As best seen in FIG. 1, a flow diagram is provided for user access to the system, which is shown in the schematic representation of FIG. 2. FIG. 1 illustrates steps for a creating user to create content, transfer the digital version of the content to a data input or repository for storage, indexing, and access, the website generating a listing or index associated with that content, including categorization, a user selecting content and an automatic generation of an account content index, and then the user using the content, such as via download of a digital copy of the content. FIG. 2 illustrates user1, user2, . . . userN interacting with a remote server or data repository through network interaction; also, a creating user accessing the remote server or data repository for uploading digital content is illustrated.

The present invention provides a method for managing licensed rights to intangible assets, in particular applied to digital media rights. Also, in particular, the present invention provides for automated licensing management with a system for which digital media content is provided for distribution to users over a network including the steps of providing a digital representation of media (DRM) available for distribution over a network, wherein the DRM is provided in a digitally recorded format (DRF) and transmittable remotely to a network portal for upload to a website; and providing the DRM in DRM unit(s) stored remotely at a data storage site(s) and available for selective download by authorized users of the network who access website (through the network portal) remotely and who are associated with an active account through the website; wherein the DRF is provided by a creator of the DRF; and wherein the DRM downloads are provided to authorized users based upon a predetermined number of simultaneous playback units of each DRM unit. Preferably, the DRM downloads are repeatedly downloadable based upon a predetermined number of downloads per DRM unit, which is associated with each authorized user, not based upon the number of devices to which the DRM is downloaded. Importantly, in sharp contrast to prior art, the DRM download does not affect the DRM availability to the authorized user, because according to the present invention, the DRM remains with the website, and is actually not transferred to the user. In one embodiment, a digital copy is downloaded by the user onto any device owned or operated by the user, in exchange for a license to use or play the DRM in accordance with the license rights granted. Preferably, the intangible asset(s) or DRM unit(s) or library remains stored on the remote server, with a user copy of the intangible asset(s) being downloaded by the licensed user.

In one model, each DRM may be priced the same. In another model, each DRM is priced according to type of media, e.g., music, movies, games, audio books, etc. In another model, each DRM within a media type may be priced the same, or may be priced differently based upon objective criteria, such as album size (number of songs per album), or may be priced subjectively by the creating user.

The business method of the present invention includes automated license management for digital media access via a network and remote content storage wherein licensed users are provided access to digital media through authorized accounts, and wherein the digital media is stored remotely, such that the licensed user has repeat access to the remotely stored media.

Significantly, with the methods and system of the present invention, the user has completely remote access to DRM that is maintained by someone other than the authorized user, and furthermore, the user has access to download and play the DRM units based upon content access within a predetermined period of time and/or based upon actual simultaneous play of any DRM unit, regardless of the format or type of device on which the DRM units are played or accessed by the user. So then if the user is traveling anywhere on the globe or airspace above the earth, or the universe, but accessing the network from a multiplicity of access devices, including but not limited to mobile phones, computers, PDAs, MP3 players, audio and/or visual players, DVRs, and the like, and combinations thereof, then the user still has access to any DRM units within that user's authorized portfolio (or collection, family, group, database, depository, repository) of DRM units, which are available for selective download and play, or direct experience (including audio and/or video) through the website portal, accessed by the authorized user through a network such as the world wide web or Internet.

The user creates their own portfolio of content in DRM, including but not limited to music, movies, audio books, podcasts, radio, news, broadcasts (stored), and the like, and combinations thereof. The portfolio index of that content is stored for each user, while the content distributor or provider stores only one digital copy of each DRM, thereby creating a singular or primary library that is remotely stored from any user or user's device(s). The portfolio index indicates which of the primary library the user has rights to access simultaneously, regardless of the device on which the user wants to access or download the content. Users can therefore access the content from any device, at any time, any place that is network accessible. The predetermined number of DRM units accessible by a single authorized user for simultaneous use is established to be between one (1) and N, where N is provided to ensure flexibility of enjoyment and use by an authorized user, but N is less than unlimited in order to ensure that the system and methods of the present invention are used, and therefore to prevent counterfeiting, illegal access or downloading, which ensures appropriate compensation to the authors, artists, and distribution entity.

Regarding the business model of the present invention including methods of doing business for digital media content creation, distribution, and automatic license management according to the present invention, the authorized users or licensed users pay a fee for access to the content, regardless of the number of access times or devices with which the content is accessed, specifically paying for each DRM unit. The DRM units selected by the authorized user is documented in that authorized user's portfolio index, which references which portions of the primary library that authorized user has rights to access. In one embodiment, for each paid content unit, or DRM unit, the authorized user pays a predetermined amount that is significantly less than other web-based models. Preferably, DRM unit access is automatically managed through the interactive content index, such that whenever the licensed or authorized user accesses DRM units by selecting them through the interactive content index on a graphic user interface associated with the website, the system automatically accounts for an access event or access activity. Alternatively, DRM unit access may be tracked or accounted for based upon download activity by the authorized or licensed user, with a fee being paid based on DRM unit access.

To manage access and to ensure that only the licensed user is actively using the user copy, the user copy is operable to be activated for use for a predetermined time from a predetermined time, such as at the time of download, the time of payment, etc. Alternatively, the user copy is operable to be activated only if it is downloaded to a device registered to the licensed user. Or a combination of the two alternatives. Additionally, the methods for licensing digital media rights according to the present invention provide for licensed user access being granted provided that simultaneous access does not exceed a predetermined number of cases within a predetermined period of time. This provides flexibility for the user to access digital media content through a valid license, while not limiting the licensed user to a copy that is fixed on a specific media, such as a DVD or CD, which is the current state of the art, as set forth hereinabove.

Within the system and methods of the present invention, the at least one intangible asset includes a digital representation of media (DRM) with copies available for distribution over a network, wherein the DRM is provided in a digitally recorded format (DRF) and transmittable remotely to a network portal for upload to a website. Preferably, the licensed rights relate to DRM units. The DRM units can be defined by a default or predetermined setting, such as an individual song in the case of music; alternatively, the DRM units can be defined by the creating user, who may opt for content pairing or bundling. Additionally, DRM units may be established based upon licensed user fees, geographic location of the licensed user and/or user account information-based geographic indication, local laws of the creating user, etc. In one embodiment of the present invention, the DRM units are established based upon predetermined number of simultaneous accesses by the licensed user within a predetermined period of time. By way of example and not limitation, the DRM units may optionally be set for a single simultaneous access within a predetermined period of time, or for multiple simultaneous access by the authorized user within a predetermined period of time, such as five (5) access interactions within one week. Tracking user access is automated based upon successful login by the authorized user to the website, and selection by the authorized user of specific DRM units. Access may be defined as user selection of DRM units, or may include downloading of DRM units by the authorized user. In the case of downloading, the licensed or authorized user is provided with a digital copy of the asset for use. This use may be further limited by time (how long the digital copy is active following the download) or by device (how many devices the digital copy is actively residing on during any given period of time, i.e., simultaneous play). So the DRM downloads may be repeatedly downloadable based upon a predetermined number of downloads per DRM unit.

The authorized user can create and maintain an active account by paying a fixed amount for a predetermined number of monthly content DRM units access, for simultaneous play of same, and/or may pay a fixed amount to increase in tiers for additional content DRM units level access. Alternatively, the authorized user may pay a fixed amount for an annual license fee, for unlimited use for content for a predetermined time, e.g., one year, that must be renewed or the content automatically expires at that time.

Uniquely, and by sharp contrast to the prior art, with the business methods of the present invention, the creative user or author/artist takes a significantly higher portion of that fee paid, such as between 20-50% of the fee paid. In this model, the artist, owner, agent, or creating user has an incentive and therefore assumes a greater role in promoting the content and policing any license; the distribution model itself aids the creating user in this endeavor. In an alternative embodiment, the payment is made by content access frequency; in this case, the pricing is incredibly low, such as between $0.01 and $0.25 per access to each content unit or DRM unit. This pricing is provided to ensure that counterfeiting is too expensive, regardless of what form. It is still easier and cheap for each individual person to have its own authorized user account, and therefore private access to their own portfolio index, than to try to coordinate with another authorized user to use their account in an unauthorized manner.

A portfolio index may be optionally shared with other authorized users, preferably for a fee; the license terms associated with this model are approved by the creating user in advance or at the time the content is initially provided in DRF to the website. By way of example to illustrate this case, and not by way of limitation of the scope of the invention, a family of four may elect to pay for 2, 3, or 4 concurrent users of the database allowing that number of users to access any combination of works simultaneously. So a family with a three-user license may be playing song A in a car, song A in the kitchen, and movie B in the den at the same time since they have paid for three people to access the database simultaneously. In one case, the licensing fee may be established on a pay-per-play basis, so that the licensing user agrees in advance to be billed according to the number of access or download activities within a predetermined period of time. In another case, the licensing fee may be established on a per month basis so that the licensing user agrees in advance that they have access to the database for the month. The next month upon paying the fee, the licensing user may have access to the same database or a different database, as defined by the user and authorized by the owner of the website and/or the author or creating user. Preferably, this is automatically managed by the system.

The system maintains an account of the devices being utilized, the owner of the device, the date and times the database is accessed, the dates and times the digital recordings are used, collection of fees from users, and disbursement of fees to authors or creating users, including sending appropriate payment accounts to appropriate tax authorities.

Furthermore, distinctions may be identified for different types of users allowing them to be charged using differing methods. For example, a movie theater may download or access a movie to be run for a number of people to view simultaneously. The artist/owner would then be paid a fee based on the number of people viewing the movie. Distinctions could be made for other types of users including schools, radio stations, dance clubs, etc where the fee could be nothing, based on number of viewers/listeners, or based on the capacity of the venue.

Creating users may pay a fee for uploading the content for a predetermined time; the annual fee could be deducted from royalty payments for purchase. That way if the content does not sell, the creating user can still keep it posted on the website for access by authorized users.

Preferably, the DRF is input directly by the creator, artist, agent, owner or authorized creative entity (hereinafter “creating user”) for distribution through the website. In one embodiment, the DRF is created by the creator or creating user at a media station having direct connectivity for upload to the website. In another embodiment, the creating user has a pre-digitally recorded copy of the content ready-to-distribute. The creating user, in any case, makes a certification that they are the true author or owner of the content they intend to provide for digital upload and distribution through the site. Additionally, the creating user has the sole decision as to what content is uploaded; it is not censored or limited, unless the content includes rated or restricted material not suitable for all users (based on age, religion, geography, etc.). For the licensing business model provided by the present invention, the licensing terms for the content is preferably provided by the creating user at the time the DRF is input to the system or website.

Optionally, there may be licensing terms that restrict content based upon predetermined criteria, such as rating and/or export restrictions. These terms are preferably indicated to the authorized user at the time of initial access.

Overall, this is simply a more efficient method of doing business in terms of digital media content creation, upload, distribution and promotion and the licensing therefor. The business model and licensing is also more efficient, because it facilitates policing and can eliminate piracy, because the honest, legal methods of doing business are simply cheaper than the cost of piracy and risk of infringement. Artists or creating users make more money and have much broader access to publication and the public, widespread distribution that is not geographically constrained. It eliminates the middleman—and the media distribution bottlenecks, like record companies, that have incredibly high overhead, costs, and long timelines associated with each artist they represent. It also eliminates the physical distribution media, the computer readable media (CRM). So the user doesn't have to continually repurchase CRM with the same content that they have already have a license for.

Certain modifications and improvements will occur to those skilled in the art upon a reading of the foregoing description. By way of example, technological advancements in media may include a form other than “digital” media; a variety of methods may be created to “download” or “access” media; numerous hand held, microchip, contact lens, ear piece, or implanted devices may be utilized to view and hear media or send the information directly to the brain; other methods of sharing a database or indexing that database could be utilized, etc. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for providing licensing rights for intangible assets comprising the steps of:
providing at least one intangible asset available for licensing;
providing automatically managed access to a licensed user following the user's acceptance of agreed upon terms for licensing;
wherein the access to the at least one intangible asset in a digital format by the licensed user is provided via a network, through a website having an interactive user interface, and wherein the at least one intangible asset in digital format is retained remotely on a computer server,
thereby providing a business model for automatically managing licensed rights with remote, electronic access to the at least one asset in a digital representation format.

2. The method of claim 1, wherein the at least one intangible asset remains stored on the remote server, with a user copy of the at least one intangible asset being downloaded by the licensed user.

3. The method of claim 2, wherein the user copy is activated for use for a predetermined time from the time of download.

4. The method of claim 2, wherein the user copy is activated only if it is downloaded to a device registered to the licensed user.

5. The method of claim 1, wherein the user's access is granted provided that simultaneous access does not exceed a predetermined number of cases within a predetermined period of time,

6. The method of claim 1, wherein the at least one intangible asset includes a digital representation of media (DRM) with copies available for distribution over a network, wherein the DRM is provided in a digitally recorded format (DRF) and transmittable remotely to a network portal for upload to a website.

7. The method of claim 1, wherein the licensed rights relate to DRM units.

8. The method of claim 7, wherein the DRM units are established based upon predetermined number of simultaneous accesses by the licensed user within a predetermined period of time.

9. The method of claim 1, wherein the network-based access to the at least one intangible asset includes providing a digital copy of the asset for use by the licensed user.

10. The method of claim 1, further including the step of the user creating an authorized user account.

11. The method of claim 1, wherein the at least one asset is automatically managed through an interactive content index.

12. The method of claim 1, further including the step of providing the DRM in DRM unit(s) stored remotely at a data storage site(s) and available for selective download by authorized users of the network who access the website remotely and who are associated with an active account through the website; wherein the DRF is provided by a creating user having rights to the DRF; and wherein the DRM downloads are provided to authorized users based upon a predetermined number of simultaneous playback units of each DRM unit.

13. The method of claim 12, wherein the DRM downloads are repeatedly downloadable based upon a predetermined number of downloads per DRM unit.

14. The method of claim 12, wherein the DRF is input directly by the creating user for distribution through the website, and the license terms are established by the creating user.
